(19) United States
(12) Patent Application Publication
(10) Pub. No.: US 2011/0059428 A1
(43) Pub. Date: Mar. 10, 2011

(54) MEMORIZATION SYSTEM

(76) Inventor: Kermit Zarley, Scottsdale, AZ (US)

(21) Appl. No.: 12/556,764

(22) Filed: Sep. 10, 2009

(51) Int. Cl. G09B 19/00

(52) U.S. Cl. 434/433

(57) ABSTRACT

A memorization system includes a housing having an open end to form a hollow chamber. A first compartment having an open end is disposed within the housing. A second compartment also is provided having a first aperture and at least one card is slidably and removably received within the second compartment. The card includes first and second columns of printed indicia wherein information in the first column is related and corresponds to information in the second column. In addition, the information in the second column of printed indicia represents information to be memorized.

### BACKGROUND OF THE INVENTION

This invention relates to a memorization system. More specifically, this invention relates to a memorization system that provides a means for memorizing and studying a large amount of information while being small, compact, and light, making it easily portable.

For as long as organized education itself has existed, individuals have developed aids to assist themselves and others in learning and memorizing information. Although a variety of memorization aids have been developed over the years, perhaps the most effective and widely utilized tool for memorization is the flash card. Typically, flash cards have information on one side, such as a word or question, and related information, such as the corresponding definition of the word or answer to the question, on the other.

Individuals seeking to learn or memorize the content of information provided on flash cards often start by simply reading each side of the cards repeatedly to gain a baseline knowledge of the information. Next, individuals quiz themselves or others by only allowing one side of the card to be viewed or known to evaluate whether the content of the information on the opposite, hidden side of the flash card has been learned. Despite the conventional and relatively simple nature of flash cards, the popularity of flash cards appears to be increasing rapidly; a popularity which can be attributed, on one hand, to the inherent simplicity of flash cards, but on the other, to the incorporation of an added level of complexity.

Flash cards can be used by virtually any individual to memorize virtually any category of information, no matter how elementary or advanced; flash cards are equally as effective in helping a grade school student learn multiplication tables as they are for use by a medical student to memorize anatomical structure. In addition, flash cards are beginning to incorporate questions and answers written by experts specialized in cognition and learning to maximize the effectiveness of their use.

Given the widespread applicability, growing popularity, and advanced nature of flash cards, the cost of flash cards is similarly increasing. Although a box of flash cards directed to unspecialized information may typically cost $10-20, flash cards containing information utilized in professional fields such as law or medicine can cost as much as $400 for a set of 6-10 boxes.

Despite their growing popularity, a potentially high cost is not the only problem associated with flash cards. A box of flash cards can contain as many as 1,000 individual cards which can prove to be cumbersome, unmanageable and heavy to a student sitting at a desk, let alone an individual who wants to study the flash cards while partaking in activities such as running errands, exercising, traveling, or the like. Furthermore, flash cards are limited in the amount of information that they can offer because flash cards are characterized by only having one word or question on one side and only one corresponding definition or answer on the other. As a result, a student or individual utilizing traditional flash cards that desires to study, learn, or memorize a large number of questions or words is going to be required to carry a separate, individual flash card for every answer or definition that is sought to be memorized. Therefore, a need exists to provide a memorization system that overcomes these problems.

Therefore, a principal object of the invention is to provide a memorization system that maximizes information retained by a user.

It is still another object of this invention to provide a memorization system that is portable.

It is still another object of this invention to provide a memorization system that is easy to use and is organized.

These and other objects, features or advantages of the present invention will become apparent from the specification and claims.

### BRIEF SUMMARY OF THE INVENTION

A memorization system includes a housing having a top, bottom, sides and an open end that forms a hollow chamber. A first compartment having an open end is disposed within the housing. A second compartment is provided having a first aperture and at least one card is slidably received within the second compartment. The second compartment has a first layer that is secured to a second layer. The card has a first side that includes first and second columns of printed indicia wherein information in the first column corresponds with related information in the second column, and each second column of printed indicia represents information to be memorized.

### BRIEF DESCRIPTION OF THE DRAWINGS

FIG. 1 is an exploded perspective view of a memorization system with a first compartment, second compartment and cards removed;

FIG. 2 is a side plan view of a memorization system with first and second compartments and cards in hidden lines;

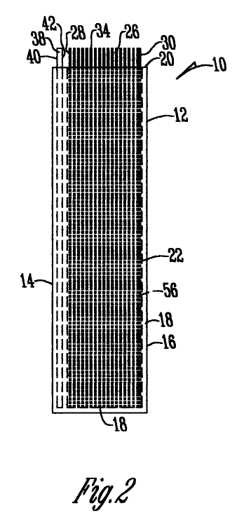

FIG. 3 is an exploded perspective view of a memorization system; and

FIG. 4 is a schematic diagram of a computer system used to make a memorization system.

### DETAILED DESCRIPTION OF THE PREFERRED EMBODIMENT

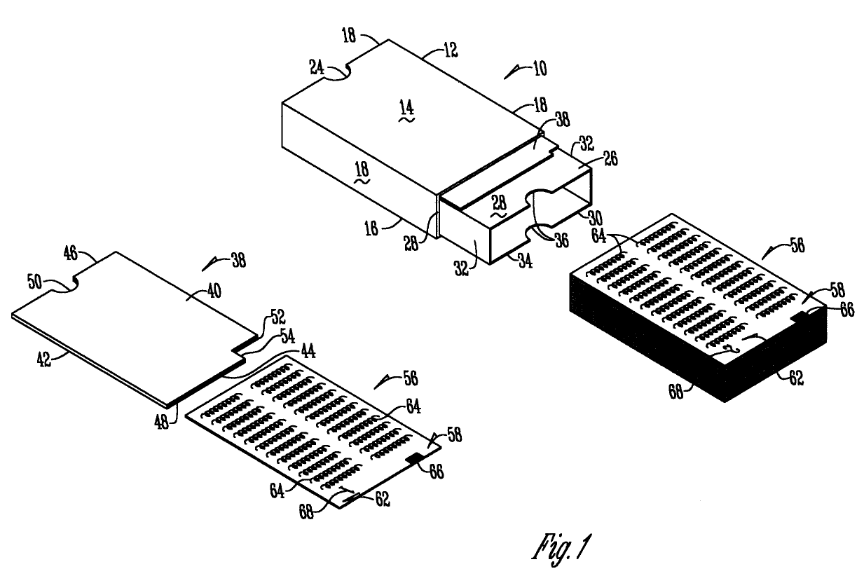

Referring to the figures, a memorization system 10 is presented. The memorization system 10 has a housing or case 12 that is made of any known suitable material. In one embodiment the housing 12 is made of clear, rigid plastic. Alternatively, the housing 12 is composed of a heavy weighted card stock. The housing 12 comprises a top 14, a bottom 16 three sides 18, and an open end 20 to surround and form a hollow chamber 22. An aperture 24 is placed in the housing 12 in order to help an individual to access the hollow chamber 22. While in FIG. 1 the aperture 24 is shown disposed through the top 14, the aperture 24 could be placed on the top 14, bottom 16, or sides 18 to help access the hollow chamber 22.

Disposed within the hollow chamber 22 is a first compartment or pack 26. In a preferred embodiment the first compartment 26 is secured to the housing 12. The first compartment 26 has a top 28, bottom 30, three sides 32, and an open end 34. Disposed through the open end 34 is a partial aperture 36 to enable the user to more easily grasp hold of a card or cards for removal.

Also disposed within the hollow chamber 22 of the housing 12 is a removable second compartment or single card holder 38. The second compartment 38 is also referred to as a jacket. Second compartment 38 comprises a first layer 40 that is secured to a second layer 42 to form a pocket 44 having a closed first end 46 and an open second end 48. Also optionally, at the first end 46 a partial aperture 50 is presented to gain access to the pocket 44. A thumb cut out also can be presented at an end 46 or 48. The second end 48 has a notch 52 disposed therein and a clear cover 54 is attached to the first layer 40 in order to cover the notch 52. In yet another embodiment a layer 40 or 42 can have a first aperture staggered above and to the side of a second aperture.

Disposed within the first compartment 26 are a plurality of cards 56. The cards 56 are of an appropriate size to allow a user to easily and conveniently place them in a back pocket of a pair of pants or inside a purse. In one embodiment the cards have a length of 5.5-6 inches and are 2.8-5 inches wide. The height and width dimensions of the cards determine the height and width dimensions of the housing 12 and first and second compartments 26 and 38. The cards 56 can be composed of any known suitable material including but not limited to heavy stock paper or suitable plastics. In one embodiment the cards are composed of 70-90 pound card stock.

Each card 56 has a first and second column 58 and 62 of printed indicia 64. The printed indicia of the second column 62 presents information related to the printed indicia of the first column 58. The printed indicia 64 includes but is not limited to words, phrases, questions, definitions, explanations, answers, translations, or the like presented. Additionally, the subject matter of the printed indicia 64 includes but is not limited to foreign languages, mathematics, chemical, cognitive equations, cognitive exercises, religious studies, history, law, medicine, information specific to a particular test (e.g., a driver's license test offered by Department of Motor Vehicles or an SAT Reasoning Test), and the like.

While in a preferred embodiment the printed indicia 64 of the first column 58 is adjacent to the printed indicia 64 of the second column 62 the printed indicia 64 of the second column could be staggered below the printed indicia 64 of the first column 58 to correspond to different embodiments of the second compartment 38. Specifically, the second compartment 38 and cards 56 are designed so that when the card 56 is in the pocket 44 printed indicia 64 of the first column 58 is revealed without revealing the related printed indicia 64 in the second column 62. Thus, a user can guess the related information of the printed indicia 64 in the second column 62 before sliding the card to reveal related item of printed indicia 64 in the second column 62.

Each card 56 includes a card categorization and organization system wherein each card 56 has an organization identifier to allow the user to identify the category of the subject matter that the card contains. For example, in one embodiment the organization identifier is a colored top 66 wherein the cards are color coded with different colored tops 66 depending upon the subject matter they contain. Cards that are categorized as containing similar subject matter can share the same shade of colored top 66. Further, the cards 56 each have a number 68 on the first and second sides to allow the user to both maintain the order of the cards or to provide a supplementary means of card identification.

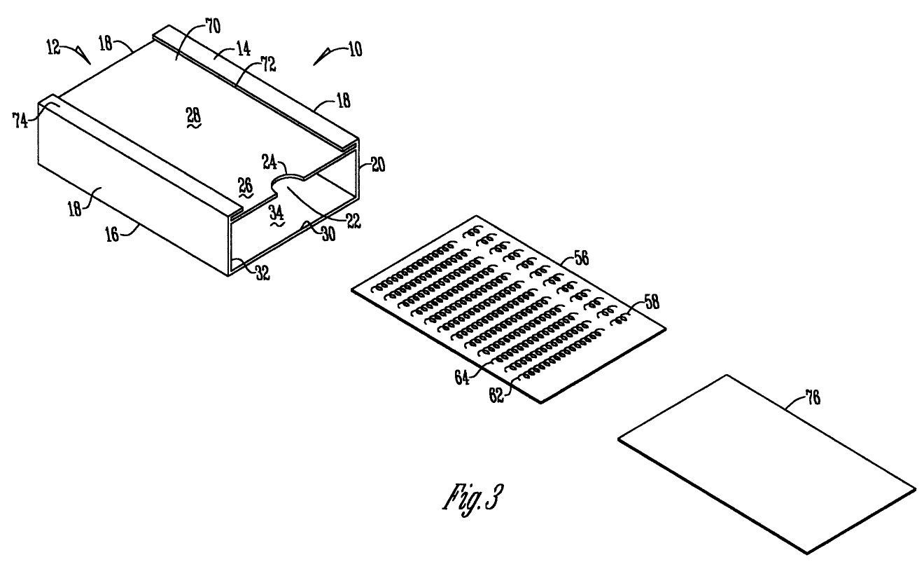

In an alternative embodiment shown in FIG. 3 the top 14 of housing 12 has an opening 70 disposed therein so that first and second pockets 72 and 74 are formed at the sides 18 of the housing. The pockets are of size and shape so that the edge of a card 56 on either side can be placed within the pocket to hold the card 56 within the housing on top of the first compartment 26. In this embodiment the second removable compartment 38 is replaced with a partial card 76 that is of size and shape that can fit into one of the first or second pockets 72 and 74 and when placed on top of a card 56, information in the first column 58 is exposed and information in the second column 62 is hidden. Thus, as with the previous embodiment presented is a memorization system that is easy to carry and simple to use improving upon the state of the art.

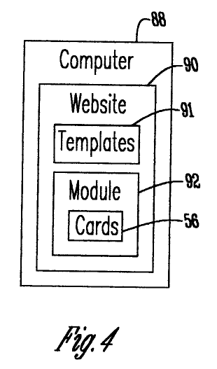

Additionally, a method of making the memorization system is presented. As best shown in FIG. 4 a computer processing unit 88 is presented. The computer processing unit or computer 88 contains software that presents and communicates with the internet or worldwide web. On the computer 88 a website 90 is presented that provides templates 91 for both the housing or case 12, the first compartment or pack 26 and second compartment or single card holder 38. Downloaded information provides indications where the housing, and first and second compartments either need to be folded, cut or attached in order to construct a memorization system 10. Thus, one only needs to download, form, cut and then attach to create a memorization system 10.

The website 90 also provides a module 92 that allows a user to custom make cards 56 to be used in association with the memorization system 10. Specifically, the module 92 requests information regarding printed indicia to be placed onto a card. For example, the module 92 in one embodiment requests a question to be placed in the first column 58 of card 56 and an answer to be placed in a corresponding second column 62 adjacent the first column 58 on the card 56. The module 92 aligns the information either side by side, staggered, in the form of a wheel, or the like depending on the template of the memorization system 10 chosen by a user. Thus, a user can choose a desired template and create their own indicia and cards to make their own customized memorization system 10.

In operation, an individual removes the second compartment 38 from the housing 10, slides a card 56, or alternatively, a few cards 56 into the pocket 44 of the second compartment 26, and carries the second compartment 26 with them, leaving the housing 12, first compartment 26, and remaining cards 56 in a permanent location. Alternatively, an individual carries the entire memorization system 10, including the housing 12, first compartment 26, second compartment 38 and cards 56, with them in a pocket, purse, or the like. The entire memorization system 10 is small, compact, and light, making it easily portable. A plurality of cards 56 are disposed within the first compartment 26 that contain information that is desired to be memorized by an individual user. When the individual decides they want to memorize information on a card 56 the second compartment 38 is removed from the housing 12. At this time a card 56 is, or alternatively, a few cards 56 are removed from the first compartment 26 and placed within the pocket 44 of the second compartment 38. Because of the notch 52 with clear cover 54 printed indicia 64 within the first column 58 is viewed by the user while the printed indicia 64 of the second column 62 is covered. Thus, a user can attempt to guess what the printed indicia 64 of the second column provides based upon the printed indicia 64 of the first column 58 that is shown. When one decides to uncover the printed indicia 64 in the second column 62 adjacent the related printed indicia 64 of the first column the card 56 can be pushed up through the partial aperture 50 in order to reveal the printed indicia 64. In this manner the individual memorizes the related information in the first and second columns 58 and 62. Furthermore, at the same time, by moving the card 56 up a second item of printed indicia 64 in the first column 58 is revealed via the notch and clear cover 52 and 54 so that the next association or relation can be determined and memorized by a user.

Thus, presented is a memorization system 10 that is portable and easy to use. Specifically, the system allows for quick and easy use so that information can be memorized. Additionally provided is a method for producing the memorization systems utilizing a website so that the systems are conveniently accessed. Thus, at the very least all of the stated objectives have been met.

It will be appreciated by those skilled in the art that other various modifications could be made to the device without departing from the spirit and scope of this invention. All such modifications and changes fall within the scope of the claims and are intended to be covered thereby.

What is claimed is:

1. A memorization system, comprising:
a housing having an open end to form a hollow chamber;
a first compartment having an open end disposed within the housing;
a second compartment removably disposed within the housing;
at least one card slidably received within the second compartment and having a first side and a second side;
first and second columns of printed indicia on the first side of the card wherein the first column corresponds with related information in the second column; and
wherein the second column of printed indicia represents information to be memorized.

2. The memorization system of claim 1 wherein the first column of printed indicia represents information to be memorized.

3. The memorization system of claim 1 wherein first and second columns of printed indicia are printed on the second side of the card.

4. The memorization system of claim 1 wherein the first compartment receives a plurality of cards.

5. The memorization system of claim 1 wherein the second compartment has a first aperture staggered above and to the side of a second aperture.

6. The memorization system of claim 1 wherein the housing, first compartment, second compartment, and cards are no wider than 5 inches and no longer than 6 inches.

7. The memorization system of claim 1 wherein the housing, first compartment, second compartment, and cards are fabricated from a template.

8. The memorization system of claim 7 wherein the template is accessed via a website, downloaded, and printed.

9. The memorization system of claim 1 wherein the indicia printed on the cards is selected to be printed on the cards via a website.
